(19) United States
(12) Patent Application Publication
(10) Pub. No.: US 2008/0298165 A1
(43) Pub. Date: Dec. 4, 2008

(54) Method for Preparing a Silicate-Based Foam, Device for Using this Method, Aerosol Can and Foam Product Obtained by the Method

(75) Inventor: Raoul Guilielmus Boudewijn Marie Prick, Maastricht (NL)

Correspondence Address: BROWDY AND NEIMARK, P.L.L.C.;624 NINTH STREET, NW, SUITE 300, WASHINGTON, DC, 20001-5303, US

(73) Assignee: MODINA B.V., Schimmert (NL)

(21) Appl. No.: 11/662,471

(22) PCT Filed: Sep. 9, 2005
(86) PCT No.: PCT/NL05/00656

§ 371 Date: Apr. 7, 2008

(30) Foreign Application Priority Data
Sep. 10, 2004 (NL) 1027015

(51) Int. Cl. B28C 5/02

(52) U.S. Cl. 366/129

(57) ABSTRACT

Method for preparing a silicate-based foam by mixing the silicate anti a pressurized carrier gas, characterized in that an accelerator, which causes the silicate to harden by chemical reaction, is added to the silicate. The accelerator can be selected from acids and acid-forming substances. While retaining the good properties and possible applications of the foam prepared in accordance with the prior art, this foam is improved by preparing a solid foam, i.e. a foam which remains foam after drying. This solid foam, inherently, i.e. without any reinforcing agent or filler, has a good dimensional stability. Devices for applying the method, an aerosol can in which the method is applied, and a prepared foam product.

The invention relates to a method for preparing a silicate-based foam by mixing the silicate and a pressurized carrier gas.

This method is known from the Applicant's Dutch patent 1 021 323 (cf. also WO 2004/018382).

The foam prepared by this method has a number of advantageous properties and possible applications. It has been possible to select or set the composition and precise quantities of the foam very accurately. On account of the presence of carrier gas a rapid drying time was obtained. It has been possible to obtain large volumes of foam; it has been possible for the volumetric ratio between the silicate and the foam produced to be up to 1:25. It has been possible for the foam to be used as an adhesive, with particular advantage for the adhesive bonding of porous materials. It has been possible to restrict the layer of adhesive to a minimum while nevertheless achieving a sufficient bonding force and the adhesive had a sufficient thickness to be able to penetrate into the pores in the material. Moreover, the foam was able to fill up unevenness on the surfaces to be adhesively bonded. It has been possible for the foam to be used on impregnatable materials such as paper, cotton, nonwoven and the like. In this context, the natural properties of silicate furnished materials of this type with fire-retardant and hydrophobic properties without making them difficult to handle, specifically more rigid. One essential difference between that foam and the liquid silicate compounds which were previously known was, for example, that the foam according to the invention was able to penetrate completely into the pores in the paper and yet remain flexible, since the impregnated paper was not completely saturated with the foam material.

Another application of the foam produced using the earlier method was as a fire-resistant agent. The material impregnated with it had an improved GCV value, since a large quantity of enclosed water molecules creates additional cooling in the event of a fire.

Use as an adhesive was also possible, and also as a binder for fibres and/or granules, as in panels or sheets of mineral wool, ceramic panels or cellulose material, and also building blocks composed of peat and woodchip panels.

The carrier gas used was preferably air, since it is available in unlimited quantities and at low cost. Other possible options were oxygen, nitrogen, carbon dioxide and carbon monoxide.

One or more surfactants were used to bring about intensive mixing of silicates and carrier gas; surfactants of this type lower the interfacial tension between carrier gas and silicates, resulting in intimate mixing of the two streams.

To impart additional properties to the foam obtained, for example in order to improve the fire resistance or to obtain an increased bonding action, agents including colorants, aromatics, foam-stabilizing agents, cleaning agents, fire-resistance increasing agents, insecticides and bonding agents, were added to the silicate.

It was possible to obtain a foam in the manner indicated with all silicates. However, sodium silicate (water glass) has the advantage of being inexpensive. Potassium silicate has the particular property of becoming transparent, whereas sodium silicate becomes opaque white. However, potassium silicate has a cost price which is a multiple of the price of water glass. Therefore, sodium silicate will generally be preferred, with a Beaum\tilde{e} rate of 20-55.

According to the earlier method, a foam was obtained which lacked stability, i.e. after a certain time it returned to liquid form.

The general object of the present invention is to improve the known method, retaining its good properties and possible uses, by preparing a solid foam, i.e. a foam which remains foam after drying.

Another object of the invention is for this solid foam inherently, i.e. without any reinforcing agent or filler, to have a good dimensional stability.

Obviously, if these objects are achieved, a range of new possibilities will present itself, as will be described in more detail below.

The method according to the present invention, in its basic concept (claim 1), is characterized in that an accelerator, which causes the silicate to harden by chemical reaction, is added to the silicate.
Preferably (claim 2), the accelerator is selected from acids and acid-forming substances.

It is known per se in chemistry that acids are able to cause silicates to harden or form a gel. However, this knowledge has never been used in the context of preparing foam.

Examples of acids which can be used in this context include lactic acid, silicic acid, tartaric acid, citric acid and formic acid.

Direct addition of acid will give rise to a very rapid reaction with the alkaline constituent of the silicate. In practice, this is only recommended for a limited number of applications. A drawback of acid is also that the mixing takes place somewhat less uniformly. By admixing a substance which forms an acid as a reaction product as soon as it enters an alkaline environment, it is possible for this acid-forming substance first of all to be mixed in and then to produce a chain reaction forming the acid, which is followed by the hardening.

The effects of the accelerator are firstly that the foam does not have the chance to settle and become liquid again, since the foam hardens as a foam. Secondly, the accelerated hardening caused by the accelerator ensures that this hardening is a chemically irreversible process. A silicate is normally completely soluble in water. Silicate which hardens naturally can be dissolved again entirely with water or steam. This is a process which is rendered irreversible by the invention. In other words: the resistance of the foam or the underlying product to water and moisture is considerably increased.

On account of the fact that according to the invention one can work with foam which can harden very quickly, it is now possible to work with products and/or add materials to the foam which are not normally compatible with silicates. Consideration may be given to materials which react chemically strangely with silicates or neutralize them. On account of the rapid hardening which is achieved according to the invention—as stated with a sufficiently large quantity of accelerator—products can be mixed which can then no longer chemically react with one another.

Whereas in the earlier method the quantity of carrier gas could be selected such that the volumetric ratio between the silicate and the foam produced was 1:approx. 25, the present improvement has advantageous new possibilities.

Firstly there is (claim 3) the range between approximately 1:2 and approximately 1:4. This will produce foamed products with an extremely low porosity, which can serve, for example, as a fire screen. A low ratio is recommended for surface treatments.

When the quantity of carrier gas is selected in such a way (claim 4) that the volumetric ratio between the silicate and the foam produced is between 1:5 and 1:50, completely different possible applications will result, in which, on account of the higher porosity, the thermal insulation properties will play a greater role. High ratios are favourable for insulation material and panel material.

In addition to the quantity of carrier gas in relation to the quantity of silicate, the quantity of accelerator which is added in accordance with the basic concept of the invention is a factor with a very wide range of possible settings, with the result that once again a large number of different types of foam can be produced. The rule when using the present inventive concept is that the greater the quantity of accelerator, the more quickly the hardening process will take place and the harder the foam prepared becomes, whereas if less accelerator is added, the open time becomes longer and it takes longer for the material to harden. Consequently, it can be handled for longer, for example when converting it into a certain shape.

In all, cases, the foam now becomes solid. It no longer has to be used as a binder for materials which have cohesion and structure, but rather can itself serve as a matrix. With the foam produced in accordance with the earlier method, one generally used about 10 to 15% of foam as binder, while the remainder was a different material with sufficient cohesion to ultimately obtain a stable panel. A “reinforcing material” in uncohesive and/or unstructured form (claim 6) can be added to the foam according to the present method, which is solid and has its own structural cohesion. This “reinforcing material” is preferably (claim 7) selected from substances such as mineral wool and glass wool.

The ratios between the foam and the other material added to it are now approximately reversed: it is possible to use (claim 10) 85-90% foam with an added quantity of uncohesive or unstructured material amounting to 10-15%. This gives rise to a range of new products which firstly are inexpensive, since they mainly comprise the foam, but also offer different properties and therefore different possible applications.

It is also possible (claim 8) to add a filler to the mixture. Such a filler may (claim 9) be gypsum or lime. The end product can then be used at all kinds of locations where gypsum-based or lime-based materials are currently used in construction, for example to fill holes.

It is still possible (claim 11) for the foam to be used as a binder. This binder can then be used for materials selected (claim 12) from mineral wool, ceramic fibres, cellulose material—all in the form of panels or sheets—building blocks composed of peat, chipboard panels or other fibres or granules. For these fillers too, a usable product is obtained if (claim 10) the filler amounts to 15% and the foam makes up 85% or more of the product which is formed.

Returning now to the preparation technique, it is noted firstly that the device described in the earlier patent application for mixing the silicate and the carrier gas can still be used when implementing the present, improved method. Therefore, no further description will be given of the device. The presence in the device of a container for additives is also retained. Additives as listed in the earlier patent can still be used. The device for using the method will therefore (claim 17) be characterized by the presence of a storage vessel for accelerator.

The fact that the present invention adds an accelerator means that new choices have to be made. The most simple embodiment (claim 13) is characterized in that the accelerator is mixed in foam form with silicate in foam form. In general, two devices as described in the earlier patent application can be used beside one another. More specifically, the device for this embodiment of the method (claim 18) is characterized by two mixing members and two nozzles, one set for mixing and spraying silicate and carrier gas, and the second set for mixing and spraying accelerator and carrier gas, with the nozzles being directed in such a way that the foam mixtures produced are mixed. Since additives will already have been mixed with the silicate, and do not need to be mixed with the accelerator, the device for producing the accelerator in foam form will not therefore need to include a container for additives of this type.

It has been found that foams which are ejected at a sufficient velocity can be mixed thoroughly and intimately, with the result that in the resulting mixture the accelerator will be present evenly throughout. This embodiment of the method can be considered for the production of industrial products such as fire-resistant panels, insulation panels and the like. One particular advantage is that this form of mixing is possible even when using high levels of the accelerator. After all, it is necessary to ensure that the rapid hardening which then takes place cannot commence even before thorough mixing has taken place. It is also necessary to prevent apertures in nozzles from becoming blocked as a result of premature hardening of the mixture.

Another embodiment with particular advantages is (claim 14) for the accelerator to be mixed in liquid form with silicate in liquid form and then for this mixture to be foamed. For what is referred to here, for the sake of simplicity, as industrial production, this embodiment may be considered when using lower percentages of accelerator, because premature hardening will not take place then.

The embodiment of the method with both the silicate and the accelerator in liquid form can specifically also be used for surface treatment. As a result of the foamed silicate first of all being applied over a product, and then the foamed accelerator being sprayed over it, the product is given a harder surface with a fire-resistant property.

Another interesting application for this method is the use as an aerosol can. This aerosol can (claim 19) then contains a silicate and an accelerator which causes the silicate to harden through chemical reaction, as well as a pressurized carrier gas.

This can be done in the form which is known per se for processing products composed of two components with an aerosol can, in which the aerosol can includes a separate core for the second component which can be broken by rotation from the bottom side of the can in order in this way to allow the mixing to take place immediately before the moment at which the mixture comprising the two components will be sprayed.

For the carrier gas, one obviously always has the possibility to choose between gaseous gas, whether or not compressed, or liquefied gas. In the context of implementing the concept of the invention in an aerosol can, the use of the carrier gas in liquid form is the best solution (claim 16). It is then also interesting (claim 15) to select the carrier gas from dimethyl ether or the light hydrocarbons such as propane, butane, isobutane.

### EXAMPLE 1

Foaming of silicate with the aid of a carrier gas up to an expansion ratio of 1:2, with the addition of 1% by weight of accelerator, gives a friable product which approximately has the properties of oasis (flower-arranging foam).

### EXAMPLE 2

Foaming of silicate with the aid of a carrier gas up to an expansion ratio of 1:2, with the addition of 15% by weight of accelerator, gives as product a panel with a very high hardness, virtually having the properties of glass.

### EXAMPLE 3

Foaming of silicate with the aid of a carrier gas up to an expansion ratio of 1:5, with the addition of 7% by weight of accelerator, gives a foam which is suitable for thin panels which can be used as a fire shield around steel claddings.

### EXAMPLE 4

Foaming of silicate with the aid of a carrier gas up to an expansion ratio of 1:10, with the addition of 6% by weight of accelerator, with the addition of 10-15% of loose rock wool gives, brought into panel form, an insulating panel for flat roofs which can be walked on.

### EXAMPLE 5

Foaming of silicate with the aid of a carrier gas up to an expansion ratio of 1:40, with the addition of 2-3% by weight of accelerator, gives as product a friable panel, extremely suitable for lightweight applications, such as thermal insulation. Especially suitable for thermos flasks and in the construction of aircraft.

Lastly, the invention (claim 22) relates to a foam product based on silicate, obtained by the above method and/or using the above device. The foam products according to the invention—when hardened and dried—are completely inorganic products which, on account of the large quantity of water enclosed therein, may be regarded as fireproof.

In a preferred embodiment (claim 23), the foam product is characterized by the presence of traces of an accelerator which has caused the silicate to harden through chemical reaction.

1. Method for preparing a silicate-based foam by mixing the silicate and a pressurized carrier gas, wherein an accelerator, which causes the silicate to harden by chemical reaction, is added to the silicate.

2. Method according to claim 1, wherein the accelerator is selected from acids and acid-forming substances.

3. Method according to claim 1, wherein the quantity of carrier gas is selected in such a way that the volumetric ratio between the silicate and the foam produced is between 1:2 and 1:4.

4. Method according to claim 1, wherein the quantity of carrier gas is selected in such a way that the volumetric between the silicate and the foam produced is between 1:5 and 1:50.

5. Method according to claim 1, wherein the quantity of accelerator amounts to at most 25% by weight of the mixture.

6. Method according to claim 1, wherein “reinforcing material” in uncohesive and/or unstructured form is added to the mixture.

7. Method according to claim 6, wherein the reinforcing material is selected from fibrous substances such as mineral wool and glass wool.

8. Method according to claim 1, wherein a filler is added to the mixture.

9. Method according to claim 8, wherein the filler is selected from gypsum and lime.

10. Method according to claim 6, wherein reinforcing material or filler is present up to an amount of 15%, and the foam makes up 85% or more of the product formed.

11. Method according to claim 1, wherein the foam is used as a binder.

12. Method according to claim 11, wherein the binder is used for materials selected from mineral wool, ceramic fibres, cellulose material—all these in the form of panels or sheets—building blocks composed of peat, chipboard panels or other fibres or granules.

13. Method according to claim 1, wherein the accelerator is mixed in foam form with silicate in foam form.

14. Method according to claim 1, wherein accelerator in liquid form and this mixture is foamed.

15. Method according to claim 14, wherein the carrier gas is selected from dimethyl ether or the light hydrocarbons such as propane, butane, isobutene.

16. Method according to claim 15, wherein the gas is used in liquid form.

17. Device for applying the method according to claim 1, comprising a storage vessel for silicate, a storage vessel for carrier gas, a mixing member and if appropriate a storage vessel for additives, as well as a nozzle, characterized by the presence of a storage vessel for accelerator.

18. Device in particular for applying the method according to claim 13, comprising a storage vessel for silicate, a storage vessel for carrier gas and if appropriate a storage vessel for additives, characterized by two mixing members and two nozzles, one set for mixing and spraying silicate and carrier gas, the second set for mixing and spraying accelerator and carrier gas, the nozzles being directed in such a way that the foam mixtures produced are mixed.

19. Aerosol can, containing a silicate and an accelerator which causes the silicate to harden through chemical reaction, as well as a pressurized carrier gas.

20. Aerosol can according to claim 19, wherein the accelerator is selected from the group consisting of acids and acid-forming substances.

21. Aerosol can according to claim 19, wherein the carrier gas is selected from dimethyl ether or the light hydrocarbons such as propane, butane, isobutene.

22. Foam product based on silicate, obtained in the manner according to claim 1.

23. Foam product according to claim 22, characterized by the presence of traces of an accelerator which has caused the silicate to harden through chemical reaction.
